(19) United States
(12) Patent Application Publication
(10) Pub. No.: US 2005/0259414 A1
(43) Pub. Date: Nov. 24, 2005

(54) Advertisement lighting device

(75) Inventor: Shunji Noda, Tokyo (JP)

Correspondence Address: MCKEE, VOORHEES & SEASE, P.L.C., 801 GRAND AVENUE, SUITE 3200, DES MOINES, IA, 50309-2721, US

(73) Assignee: NODA DENKI KOGYO KABUSHIKI KAISHA, Tokyo (JP)

(21) Appl. No.: 10/847,993

(22) Filed: May 18, 2004

(51) Int. Cl. F21S 4/00

(52) U.S. Cl. 362/223; 362/339; 362/225; 362/298

(57) ABSTRACT

An advertisement lighting device has a fluorescent lamp in a casing. In front of and closer to the fluorescent lamp, a prism is provided to disperse light radiated from the fluorescent lamp. A reflecting plate is formed on the back of the casing to reflect light radiated directly from the fluorescent lamp and light dispersed through the prism to achieve uniform luminous intensity.

### BACKGROUND OF THE INVENTION

The present invention relates to an advertisement lighting device situated on the wall of a station or underground shopping arcade.

On the wall, an advertisement comprises transparent or translucent material, and behind the advertisement, rod-like light emitting elements such as a number of fluorescent lamps are provided. On the back of the advertisement, a milky diffusing plate is placed and looks like a light source.

FIGS. 9 and 10 are a front elevational view and a central vertical sectional view of a known advertisement lighting device respectively. A milky diffusing plate 103 is provided on a casing 102 of an advertisement lighting device 101 and on the back of the diffusing plate 103, a plurality of horizontal fluorescent lamps 104 such as two are disposed vertically. Behind the fluorescent lamps 104, a reflecting plate 105 is provided to reflect light radiated from the fluorescent lamp. The milky diffusing plate 105 diffusely reflects light that comes straight from the back and looks like white emanation by itself, seen from the front regardless of a viewing direction. An advertisement 106 on a transparent or translucent base plate is provided in front of the diffusing plate 103, and the front surface of the advertisement 105 is covered with a transparent protecting plate 107 such as a glass or acryl plate to provide an advertisement medium.

A wall hanging advertisement medium in an underground shopping arcade includes a plurality of light sources and requires lighting for 18 to 24 hours. As space between the light sources is larger, uneven light materializes on the diffusing plate. By increasing the number of the fluorescent lamps, the space is made as small as possible.

However, between adjacent fluorescent lamps, there are higher and lower luminous intensities vitiating surface light source. FIGS. 11 and 12 are three dimensional graphs showing light distribution of a left sampling area of the lower fluorescent lamp 104 in FIG. 9.

As shown in the graphs, in middle longitudinal divisions S5 and S6 of the fluorescent lamp 104 which is closest to the diffusing plate 103, luminous intensity is the highest, and in longitudinal divisions S10 and S1 far from an axis, luminous intensity decreases significantly.

This is because luminous intensity decreases in inverse proportion to the square of a distance from the light source. As distance from the two light sources becomes longer, luminous intensity decreases significantly at a boundary compared with the front face of the light source. However, if space between the two fluorescent lamps 104 decreases to overcome ununiformness of luminous intensity, the number of fluorescent lamps increases per one fluorescent lamp resulting in higher electricity cost. Furthermore, even if the whole light amount increases by increasing the number of fluorescent lamps, the overall advertisement lighting effect doe not increase significantly.

### SUMMARY OF THE INVENTION

In view of the foregoing disadvantages, it is an object of the invention to provide an advertisement lighting device for decreasing deviation to the middle of fluorescent lamp of radiation of the flurescent lamps in the flat advertisement lighting device to achieve unification, lighting a broader range of the advertisement without losing lighting effect as area light source and saving electric power consumption.

### BRIEF DESCRIPTION OF THE DRAWINGS

The above and other features and advantages of the invention will become more apparent from the following description with respect to embodiments as shown in appended drawings wherein:

FIG. 1 is a front elevational view of one embodiment of an advertisement lighting device according to the present invention;

FIG. 2 is a central vertical sectional side view thereof;

FIG. 3 is a perspective view of a support plate for supporting a light beam divider;

FIG. 4 is a view of light paths of an embodiment in which a prism is employed as light beam divider;

FIG. 5 is a three dimensional graph of luminous intensity distribution having luminous intensity as vertical axis over lower left quarter of FIG. 1, seen in perspective from the left of the sampling area;

FIG. 6 is a three dimensional graph seen in perspective from the right of the sampling area thereof;

FIG. 7 is a view of light paths in which a half mirror is employed as light beam divider;

FIG. 8 is a view of light paths in which a porous plate is employed as light beam divider;

FIG. 9 is a front elevational view of a known advertisement lighting device;

FIG. 10 is a central vertical sectional side view of FIG. 9;

FIG. 11 is a three dimensional graph having luminous intensity as vertical axis over a left lower quarter of sampling area, seen in perspective from the left of the sampling area; and

FIG. 12 is a three dimensional graph seen in perspective from the right of the sampling area.

### DETAILED DESCRIPTION OF PREFERRED EMBODIMENTS

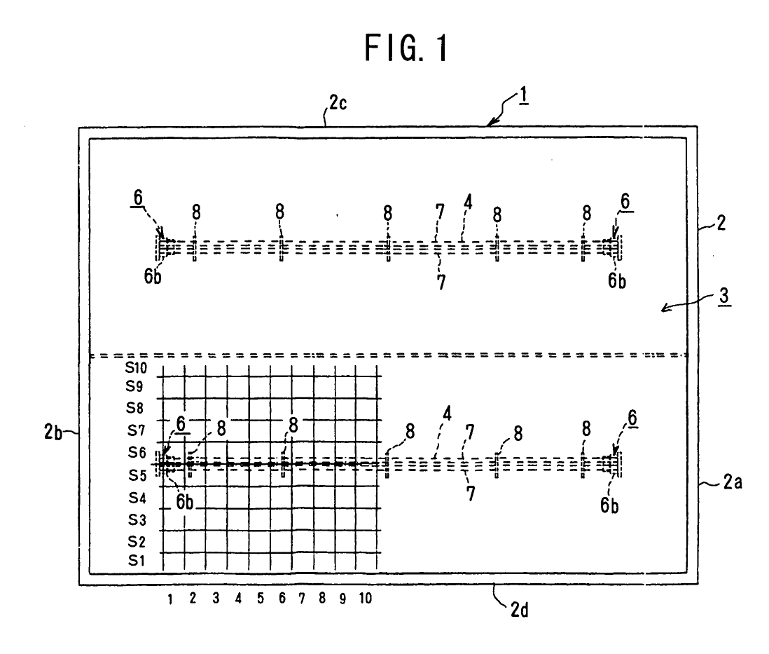

In an advertisement lighting device 1 as shown in FIGS. 1 and 2, a diffusing plate 3 is provided in the front of a casing 2, and behind the diffusing plate 3, one or more horizontal straight-tube light sources such as two horizontal fluorescent lamps 4 are provided in parallel with a radiated surface 3a of the diffusing plate 3. Behind each of the fluorescent lamps 4, a reflecting plate 5 is provided respectively.

The right and left ends of the reflecting plate 4 contact a right frame member 2a and a left frame member 2b. Each of the fluorescent lamps 4 is provided in the middle of upper and lower halves respectively. The upper end 5a of the upper reflecting plate 5 and lower end 5b of the lower reflecting plate 5 contacts an upper frame member 2c and a lower frame member 2d of the casing 2 respectively.

The upper and lower reflecting plates 5 are connected to each other by connecting the lower end 5b of the upper reflecting plate 5 to the upper end 5a of the lower reflecting plate 5. On the back of the reflecting plate 5, a back plate 2e for the casing 2 is provided. In sockets 6 of the fluorescent lamp 4, a base 6a is fixed to the back plate 2e and a connecting portion 6b is projected forward on the reflecting plate 5.

In a portion in which the radiated surface 3a of the diffusing plate 3 is the closest to the surface of each of the fluorescent lamps 4 or the front surface of the fluorescent lamps 4, on upper and lower parts of the fluorescent lamps 4, there are one or more light beam dividers “A”, such as two prisms 7 for partially dividing light beam radiated from the fluorescent lamps 4 forwards, approximately in parallel with the diffusing plate 3. The prisms 7 are vertically symmetrical in section to each other with respect to an axis of the lamp 4.

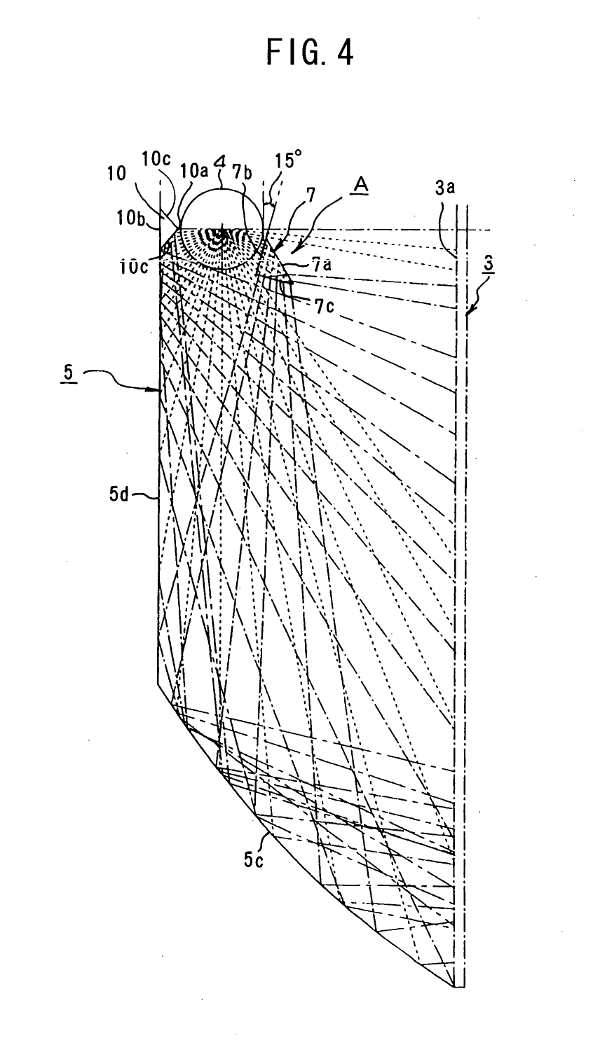

FIG. 4 is a view which shows lower light paths. Upper light paths are symmetrical with the lower light paths and are omitted. The prisms 7 are spaced longitudinally of the fluorescent lamp 4 and fixed by support plates 8 in front of the fluorescent lamp 4 with a proper angle as shown in FIG. 4. The prisms 7 may be supported by springs wound on the fluorescent lamp 4.

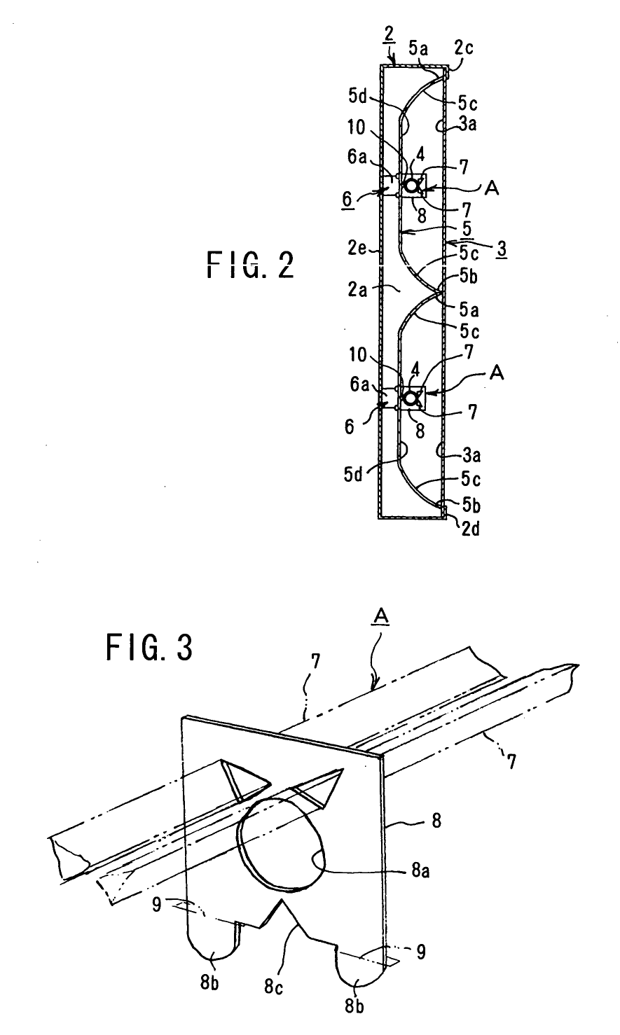

As shown in FIG. 3, a bore 8a through which the fluorescent lamp 4 passes is formed in the support plate 8 and projecting portions 8b are provided on the lower end to engage in positioning bores 9 of the reflecting plate 5. Behind the fluorescent lamp 4, a reflector 10 is provided. As shown in FIG. 4, the reflector 10 has an isosceles triangular section. An apex line 10a of the triangle is fitted with the axis of the fluorescent lamp 4 and extends longitudinally in parallel with the fluorescent lamp. The reflector 10 has a base 10b on the reflecting plate 5. The support plate 8 has a notch 8c which is engaged over the reflector 10 close to the bore 8a through which the fluorescent lamp 4 passes. A mirror is formed on the surface of a side 10c of the reflector 10 to reflect light radiated from the fluorescent lamp 4 sideward.

The light beam divider or prism 7 in front of the fluorescent lamp 4 is a right-angle prism which comprises a right isosceles triangle, a base of which directs forwards. A side 7b which has an acute angle with respect to the base 7a is inclined with respect to the radiated surface 3a of the diffusing plate 3 by 15 degrees. In the prism 7, light is incident through the side 7b and leaves the other side 7c which is normal to the side 7b. Light partially disperses approximately in parallel with the radiated surface 3a of the diffusing plate 3. The reflecting plate 5 has a sideward reflecting portion 5c which reflects light directly radiated from the fluorescent lamp 4 and dispersed through the prism 7, toward the radiated surface 3a; and a rear reflecting portion 5d which reflects light directly radiated from the fluorescent lamp 4 toward the radiated surface 3a.

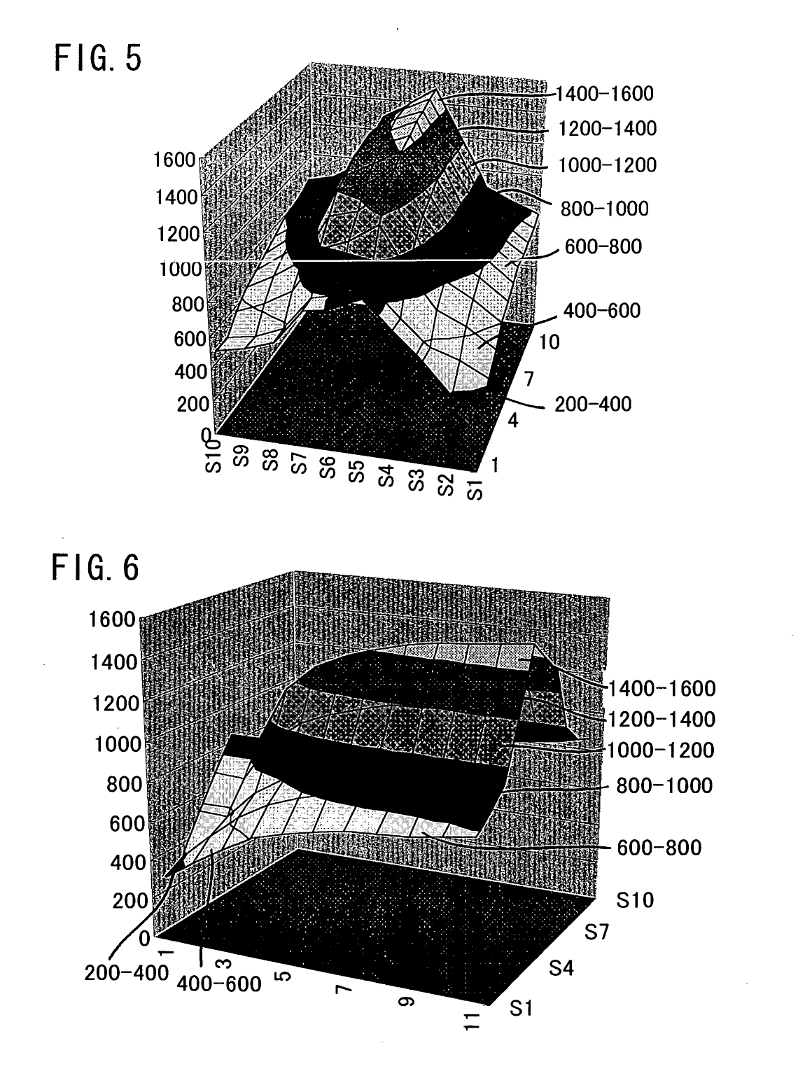

FIGS. 5 and 6 are three dimensional graphs in which luminous intensities are measured in a left-half sample area of the lower luminescent lamp 4. FIG. 5 is a three dimensional graph of the area seen in perspective from a left-upper side and FIG. 6 is a three dimensional graph of the area seen in perspective from a right side.

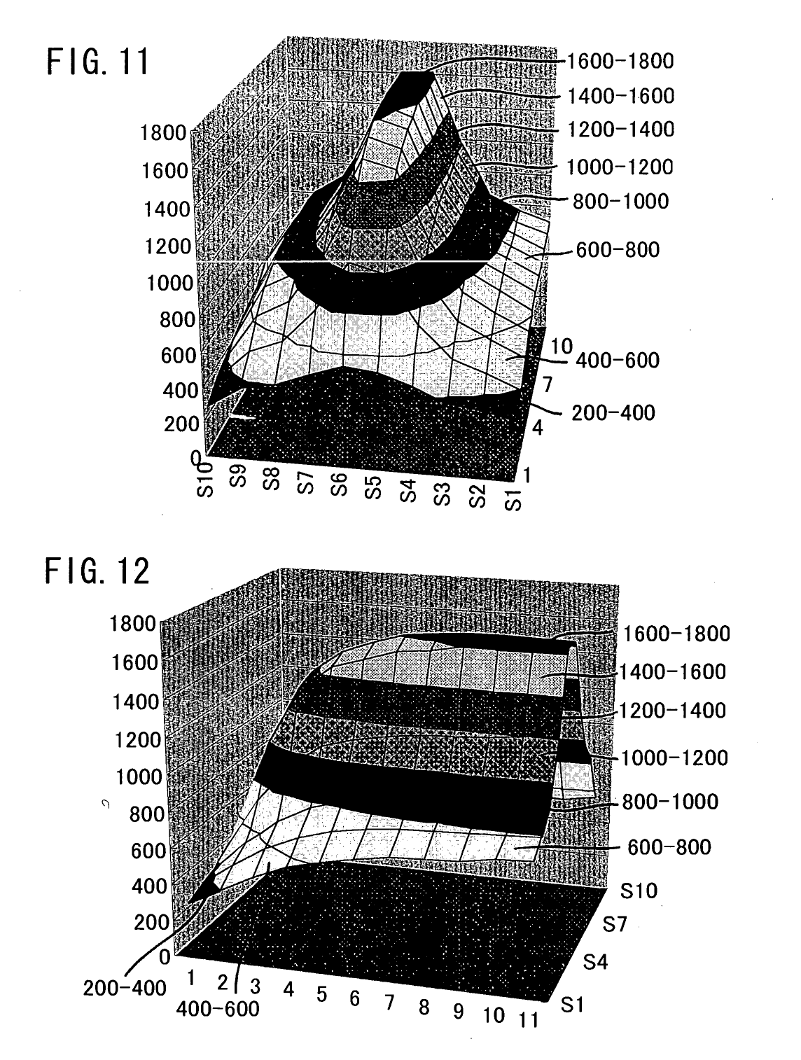

According to the present invention, compared with the graphs shown as prior art in FIGS. 11 and 12, in transverse divisions 6 to 11 of longitudinal divisions S5 and S6 corresponding to the front face of the luminescent lamp 4, luminous intensity significantly decreases to about cd 200, and intermediate value division having luminous intensity of cd 800 increases vertically.

In FIGS. 11 and 12 as prior art, measured division having luminous intensity of cd 800 does not reach upper longitudinal division S10 and lower longitudinal division S1, while in FIGS. 5 and 6 relating to the present invention, measured division having luminous intensity of cd 800 reaches to upper longitudinal division S10 and lower longitudinal division S1.

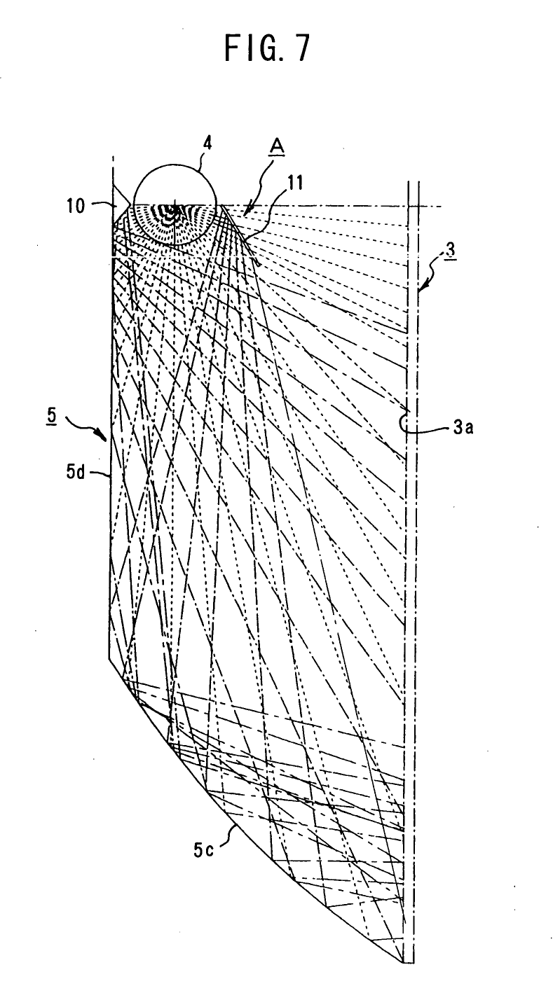

FIG. 7 illustrates another embodiment in which the light beam divider “A” is a half mirror 11. The same numerals are allotted to the same members as those in the former embodiment, and detailed description thereof is omitted.

The half mirror 11 is fixed in front of a fluorescent lamp 4 at angles such that incident light beam to the half mirror 11 is partially reflected to a sideward reflecting portion 5c. Light beam which passes through the half mirror reaches to a diffusing plate 3, but the distance is short. Consequently, light source permeability through the half mirror may be low. Permeability is determined such that luminous intensity in front of the fluorescent lamp 4 is an average value of each division, approximately cd 1000.

As light energy through the half mirror 11 hardly dissipates, light beam reflected sideward increases luminous intensity of outer divisions to equalize luminous intensity of the whole divisions, so that the diffusing plate 3 becomes closer to an ideal surface light source.

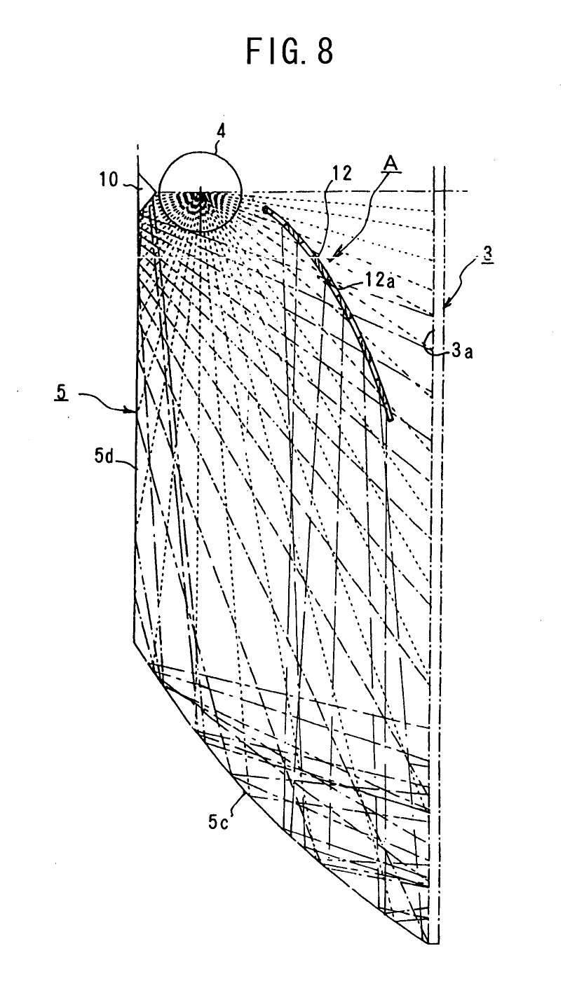

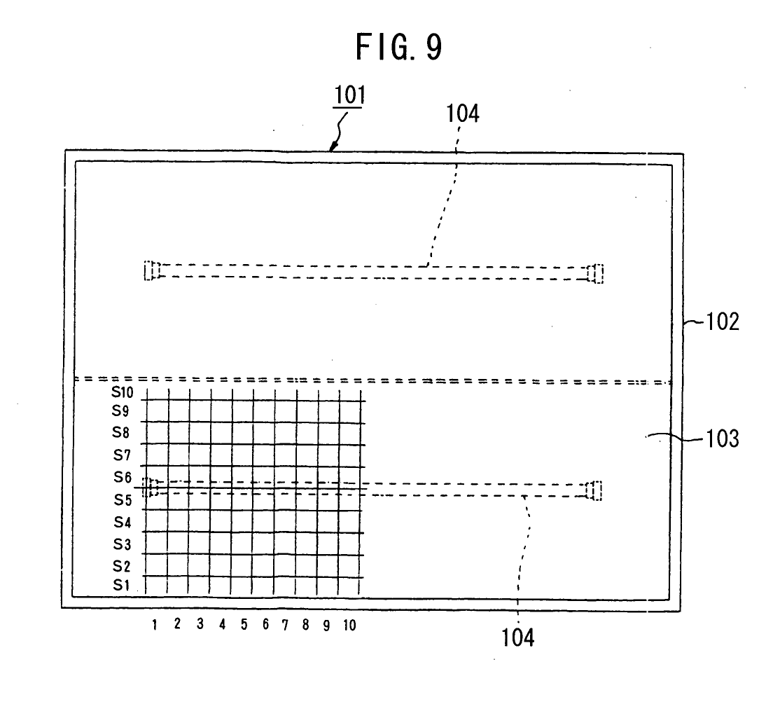

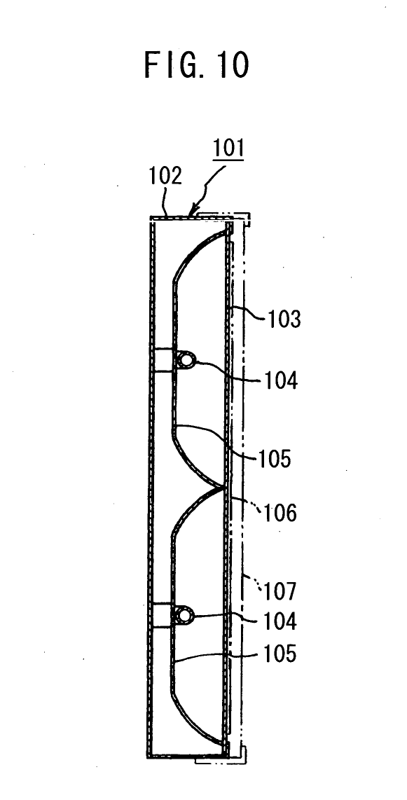

FIG. 8 illustrates further embodiment in which the light beam divider “A” is a porous punching panel 12. The punching panel 12 comprises a high-density pitch structure in which a number of circular bores are formed at the apex of hexagon, area rate of the bores 12a being 50 to 70% or being increased outward gradually. The punching panel 12 made of Al is polished at the back side to form a mirror. The punching panel 12 is easily worked and less expensive. Thus, a larger area panel 12 is easily employed, so that wider light beam can be dispersed sideward. Furthermore, permeability of light beam is variable depending on incident angle of light beam to the punching panel 12, making it possible to control equalization in detail depending on bending of the punching panel 12.

The foregoing merely relates to embodiments of the invention. Various changes and modifications may be made by a person skilled in the art without departing from the scope of claims wherein:

1. An advertisement lighting device comprising:
a straight tubular light source having axis in parallel with a radiated surface;
a reflecting plate behind the light source, having a rear reflecting portion and a sideward reflecting portion, said rear reflecting portion reflecting from the light source; and
a light beam divider in front of and closer to the light source between the light source and the radiated surface, radiated light beam from the light source being partially reflected by the sideward reflecting portion of the reflecting plate.

2. A device as claimed in claim 1 wherein the straight tubular light source comprises a fluorescent lamp.

3. A device as claimed in claim 1 wherein the light beam divider is supported by a plurality of support plates through which the divider passes.

4. A device as claimed in claim 1 wherein the light beam divider comprises a prism.

5. A device as claimed in claim 1 wherein the light beam divider comprises a half mirror.

6. A device as claimed in claim 1 wherein the light beam divider comprises a porous punching panel having a number of bores for passing through light radiated from the light source, a mirror is formed on the back of the panel to reflect the light beam toward the sideward reflecting portion of the reflecting plate.

7. A device as claimed in claim 1 wherein an isosceles triangular reflecting portion is provided on the rear reflecting plate behind the light source to reflect light from the light source.
